(19) United States
(12) Patent Application Publication
(10) Pub. No.: US 2015/0091926 A1
(43) Pub. Date: Apr. 2, 2015

(54) DISPLAY PANEL UPDATES BASED ON HARDWARE CONTENT CHANGE DETECTION AND GRAPHICS PROCESSOR ACTIVITY

(71) Applicants: Saran Chandra, Bangalore (IN); Sumit Jain, Bangalore (IN)

(72) Inventors: Saran Chandra, Bangalore (IN); Sumit Jain, Bangalore (IN)

(21) Appl. No.: 14/498,184

(22) Filed: Sep. 26, 2014

(30) Foreign Application Priority Data
Sep. 27, 2013 (IN) 4407/CHE/2013

(51) Int. Cl. G06T 1/60

(52) U.S. Cl. CPC G06T 1/60
USPC 345/545

(57) ABSTRACT

Systems and methods may provide for detecting a content change with respect to one or more frame buffers associated with a display panel and identifying a command set associated with a previous update of the display panel. Additionally, the command set may be re-used to conduct a subsequent update of the display panel. In one example, the subsequent update of the display panel bypasses one or more drivers associated with the display panel. In addition, a determination may be made that graphics processor activity has occurred while the display panel is in a self refresh mode. In such a case, a self refresh update of the display panel may be conducted in response to the graphics processor activity.

### TECHNICAL FIELD

Embodiments generally relate to display panels. More particularly, embodiments relate to conducting display panel updates based on the detection of content changes and/or graphics processor activity.

### BACKGROUND

Display panels may be used to present visual content to users on a wide variety of computing devices. In certain cases, software applications may coordinate with a graphics driver in the creation of the visual content, wherein the graphics driver may store the visual content to one or more frame buffers. Additionally, a display driver may send commands to display hardware in order to transfer the content from the frame buffers to the display panel. Thus, as new content is created, a switch may occur from one frame buffer to the next, wherein the display driver may issue a new set of commands to the display hardware upon each frame buffer switch (e.g., “display flip”). In certain situations, however, frame buffer switches may not be conducted as new content is created. For example, some applications may use only a single frame buffer and/or may update the frame buffers without operating system (OS) awareness. As a result, display accuracy, power consumption, battery life and/or the user experience may be negatively impacted.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a computing architecture in which display updates are triggered by content changes according to an embodiment;

FIG. 2 is a block diagram of an example of a computing architecture in which display updates are triggered by graphics processor activity according to an embodiment;

FIG. 3 is a block diagram of an example of a computing architecture in which display updates are triggered by content changes and graphics processor activity according to an embodiment;

FIGS. 4A and 4B are flowcharts of examples of methods of conducting display updates according to embodiments.

### DESCRIPTION OF EMBODIMENTS

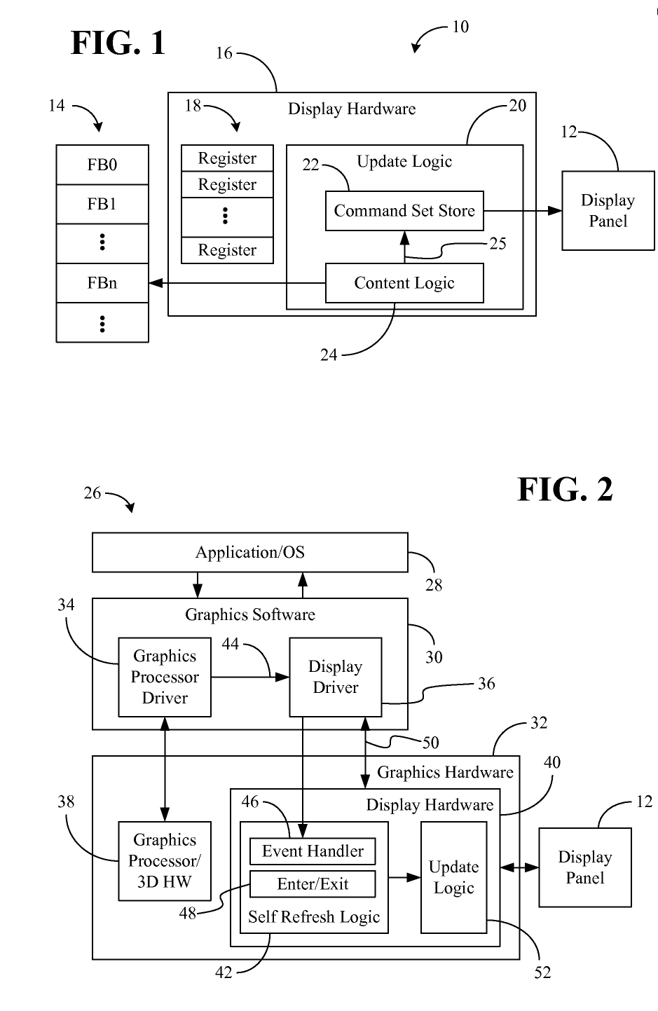

Turning now to FIG. 1, a computing architecture 10 is shown in which display updates may be triggered by content changes with respect to one or more frame buffers 14 associated with a display panel 12 (e.g., liquid crystal display/LCD, light emitting diode/LED display, touch screen, etc.). The frame buffers 14 may generally be used to store visual content prior to presenting the visual content on the display panel 12. For example, a first frame buffer “FB0” might contain the color values (e.g., on a pixel-by-pixel basis) for a particular frame in a video signal, a second frame buffer “FB1” may contain the color values for a subsequent frame in the video signal, and so forth.

The architecture 10 may also include display hardware 16 configured to operate in a command mode in which one or more control registers 18 and update logic 20 provide for the updating of content shown on the display panel 12 based on one or more commands written to a command set store 22 (e.g., storage for one or more commands). The commands may include, for example, one or more Mobile Industry Processor Interface (MIPI) commands or other commands suitable for conducting display updates. The command mode may differ from, for example, a pixel streaming mode in which display updates may occur for each vertical-synchronization (vertical-sync) of the visual content.

As will be discussed in greater detail, the update logic 20 may also include content logic 24 configured to detect content changes with respect to the one or more frame buffers 14. For example, the content logic 24 might determine that the content stored in frame buffer “FBn” has changed. In response to detecting a particular content change, the content logic 24 may also issue a trigger 25 to identify one or more commands (e.g., a command set) associated with a previous update of the display panel 12 and re-use that command set to conduct a subsequent update of the display panel 12. In one example, the content logic 24 checks the frame buffers 14 for content changes on a periodic basis such as, for example, after each frame duration. Thus, the subsequent update may bypass one or more drivers (not shown) associated with the visual content and/or display panel 12 and substantially improve the accuracy of the content output via the display panel 12. As a result, the user experience may also improve, particularly in cases where content stored in the frame buffers 14 may change without “display flips” being initiated by the drivers, operating system (OS) and/or software application.

FIG. 2 shows a computing architecture 26 in which display updates may be triggered by graphics processor activity when a display refresh mode is active. The illustrated architecture 26 includes a display panel 12, an application (e.g., application software, OS) 28, graphics software 30 and graphics hardware 32. The graphics software 30 may generally include a graphics processor driver 34 that executes on a graphics processor (e.g., graphics processing unit/GPU, three-dimensional hardware/3D HW) in order to assist the application 28 in creating/rendering visual content, wherein a display driver 36 may use display flips to update the output of the display panel 12.

The graphics hardware 32 may also include display hardware 40 having self refresh logic 42 to determine that graphics processor activity has occurred while the display panel 12 is in a self refresh mode. In this regard, the OS and/or application 28 may generally place the display panel 12 in the self refresh mode in order to conserve power during periods of expected inactivity. In one example, the graphics processor driver 34 may issue an activity notification 44 to the display driver 36, which may in turn set an activity bit in the display hardware 40 (e.g., set a bit in a register, not shown) in order to notify an event handler 46 that the graphics processor activity has occurred.

In response to the graphics processor activity, an enter/exit module 48 of the self refresh logic 42 may conduct a self refresh update of the display panel 12. The self refresh update may involve exiting the self refresh mode, updating the display panel 12, and re-entering the self refresh mode, wherein updating the display panel 12 may involve using update logic 52 and one or more commands 50 provided by the display driver 36. Of particular note is that the occurrence of the graphics processor activity may be determined without notification of a frame buffer switch, in the example shown.

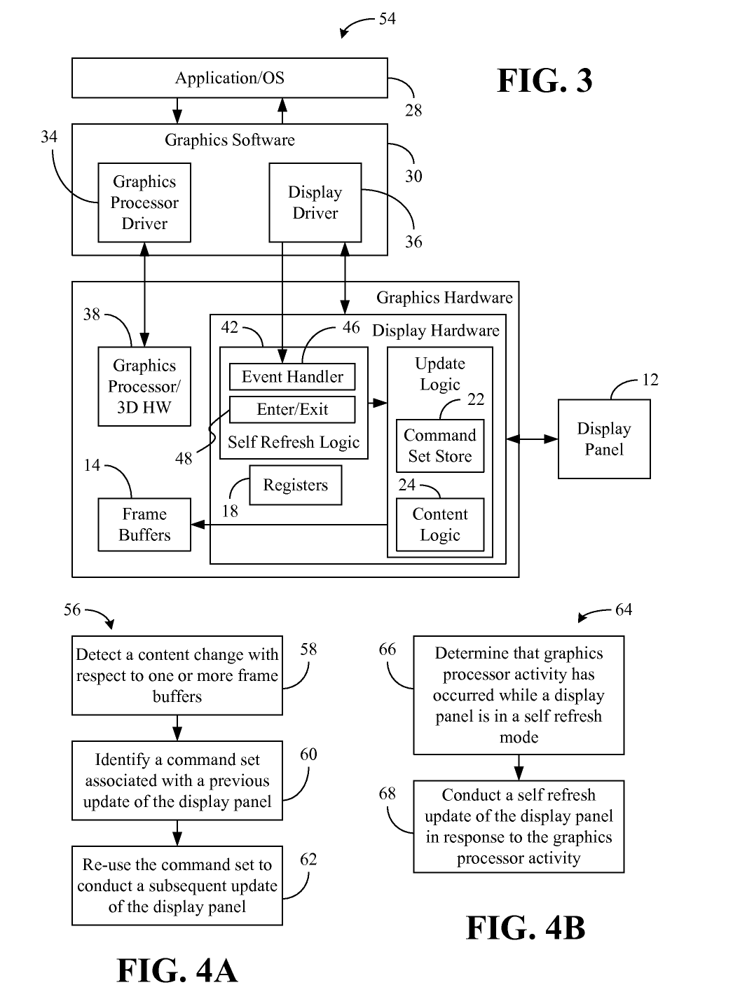

The illustrated approach may therefore conserve power by conducting display updates without activating vertical-sync reporting. Moreover, the user experience may be enhanced by avoiding redundant image situations. Additionally, performance overhead may be minimized by setting the activity bit only when there is graphics processor activity in self refresh mode. FIG. 3 shows a computing architecture 54 in which display updates may be triggered by both content changes with respect to the frame buffers 14 and graphics processor activity while the display panel 12 is in the self refresh mode. The computing architecture 10, 26 and 54 illustrated in FIGS. 1-3 may be part of a server, workstation, desktop computer, notebook computer, smart tablet, convertible tablet, smart phone, personal digital assistant (PDA), mobile Internet device (MID), media player, and so forth, and may include one or more system on chip (SoC) configurations to implement the components and/or functionality shown therein.

Turning now to FIG. 4A, a method 56 of conducting display updates based on content changes is shown. The method 56 may be implemented as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, the method 56 may be implemented in the update logic 20 (FIG. 1), already discussed.

Illustrated processing block 58 provides for detecting a content change with respect to one or more frame buffers associated with a display panel, wherein a command set associated with a previous update of the display panel may be identified at block 60. Block 58 may also involve checking the one or more frame buffers on a periodic basis such as, for example, after each frame duration. Additionally, illustrated block 62 re-uses the command set to conduct a subsequent update of the display panel, wherein the subsequent update may bypass one or more drivers associated with the display panel.

FIG. 4B shows a method 64 of conducting display updates based on graphics processor activity is shown. The method 64 may be implemented as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof. For example, the method 64 may be implemented in the self refresh logic 42 (FIG. 2), already discussed.

Illustrated processing block 66 provides for determining that graphics processor activity has occurred while a display panel is in a self refresh mode. As already discussed, determining that the graphics processor activity has occurred may involve checking an appropriate activity bit. Moreover, the occurrence of the graphics processor activity may be determined without notification of a frame buffer switch (e.g., display flip call). Additionally, a self refresh update of the display panel may be conducted at block 68 in response to the graphics processor activity. The self refresh update may include exiting the self refresh mode, updating the display panel, and re-entering the self refresh mode.

### Additional Notes and Examples

Example 1 may include a system comprising a display panel, one or more frame buffers associated with the display panel and content logic, implemented at least partly in fixed-functionality hardware. The content logic may detect a content change with respect to the one or more frame buffers, identify a command set associated with a previous update of the display panel and re-use the command set to conduct a subsequent update of the display panel.

Example 2 may include the system of Example 1, wherein the subsequent update of the display panel is to bypass one or more drivers associated with the display panel.

Example 3 may include the system of Example 1, wherein the content logic is to check the one or more frame buffers for the content change on a periodic basis.

Example 4 may include the system of any one of Examples 1 to 3, further including a graphics processor, and self refresh logic, implemented at least partly in fixed-functionality hardware, to determine that graphics processor activity has occurred while the display panel is in a self refresh mode, and conduct a self refresh update of the display panel in response to the graphics processor activity.

Example 5 may include the system of Example 4, wherein the self refresh logic is to check an activity bit to determine that the graphics processor activity has occurred.

Example 6 may include the system of Example 4, wherein the occurrence of the graphics processor activity is to be determined without notification of a frame buffer switch.

Example 7 may include a method of conducting display updates, comprising detecting a content change with respect to one or more frame buffers associated with a display panel, identifying a command set associated with a previous update of the display panel and re-using the command set to conduct a subsequent update of the display panel.

Example 8 may include the method of Example 7, wherein the subsequent update of the display panel bypasses one or more drivers associated with the display panel.

Example 9 may include the method of Example 7, further including checking the one or more frame buffers for the content change on a periodic basis.

Example 10 may include the method of any one of Examples 7 to 9, further including determining that graphics processor activity has occurred while the display panel is in a self refresh mode, and conducting a self refresh update of the display panel in response to the graphics processor activity.

Example 11 may include the method of Example 10, wherein determining that the graphics processor activity has occurred includes checking an activity bit.

Example 12 may include the method of Example 10, wherein the occurrence of the graphics processor activity is determined without notification of a frame buffer switch.

Example 13 may include at least one computer readable storage medium comprising a set of instructions which, if executed by a computing device, cause the computing device to detect a content change with respect to one or more frame buffers associated with a display panel, identify a command set associated with a previous update of the display panel, and re-use the command set to conduct a subsequent update of the display panel.

Example 14 may include the at least one computer readable storage medium of Example 13, wherein the subsequent update of the display panel is to bypass one or more drivers associated with the display panel.

Example 15 may include the at least one computer readable storage medium of Example 13, wherein the instructions, if executed, cause the computing device to check the one or more frame buffers for the content change on a periodic basis.

Example 16 may include the at least one computer readable storage medium of any one of Examples 13 to 15, wherein the instructions, if executed, cause the computing device to determine that graphics processor activity has occurred while the display panel is in a self refresh mode, and conduct a self refresh update of the display panel in response to the graphics processor activity.

Example 17 may include the at least one computer readable storage medium of Example 16, wherein the instructions, if executed, cause the computing device to check an activity bit to determine that the graphics processor activity has occurred.

Example 18 may include the at least one computer readable storage medium of Example 16, wherein the occurrence of the graphics processor activity is to be determined without notification of a frame buffer switch.

Example 19 may include an apparatus to conduct display updates, comprising content logic, implemented at least partly in fixed-functionality hardware, to detect a content change with respect to one or more frame buffers associated with a display panel, identify a command set associated with a previous update of the display panel and re-use the command set to conduct a subsequent update of the display panel.

Example 20 may include the apparatus of Example 19, wherein the subsequent update of the display panel is to bypass one or more drivers associated with the display panel.

Example 21 may include the apparatus of Example 19, wherein the content logic is to check the one or more frame buffers for the content change on a periodic basis.

Example 22 may include the apparatus of any one of Examples 19 to 21, further including self refresh logic, implemented at least partly in fixed-functionality hardware, to determine that graphics processor activity has occurred while the display panel is in a self refresh mode, and conduct a self refresh update of the display panel in response to the graphics processor activity.

Example 23 may include the apparatus of Example 22, wherein the self refresh logic is to check an activity bit to determine that the graphics processor activity has occurred.

Example 24 may include the apparatus of Example 22, wherein the occurrence of the graphics processor activity is to be determined without notification of a frame buffer switch.

Example 25 may include an apparatus to conduct display updates, comprising means for performing the method of any one of Examples 7 to 12.

Thus, techniques described herein may improve display accuracy, power consumption, battery life and/or the user experience in architectures that do not always conduct frame buffer switches when new visual content is created. Moreover, the techniques may be useful in command mode and/or self refresh mode.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a display panel;
one or more frame buffers associated with the display panel; and
content logic, implemented at least partly in fixed-functionality hardware, to,
detect a content change with respect to the one or more frame buffers,
identify a command set associated with a previous update of the display panel, and
re-use the command set to conduct a subsequent update of the display panel.

2. The system of claim 1, wherein the subsequent update of the display panel is to bypass one or more drivers associated with the display panel.

3. The system of claim 1, wherein the content logic is to check the one or more frame buffers for the content change on a periodic basis.

4. The system of claim 1, further including:
a graphics processor; and
self refresh logic, implemented at least partly in fixed-functionality hardware, to,
determine that graphics processor activity has occurred while the display panel is in a self refresh mode, and
conduct a self refresh update of the display panel in response to the graphics processor activity.

5. The system of claim 4, wherein the self refresh logic is to check an activity bit to determine that the graphics processor activity has occurred.

6. The system of claim 4, wherein the occurrence of the graphics processor activity is to be determined without notification of a frame buffer switch.

7. A method comprising:
detecting a content change with respect to one or more frame buffers associated with a display panel;
identifying a command set associated with a previous update of the display panel; and
re-using the command set to conduct a subsequent update of the display panel.

8. The method of claim 7, wherein the subsequent update of the display panel bypasses one or more drivers associated with the display panel.

9. The method of claim 7, further including checking the one or more frame buffers for the content change on a periodic basis.

10. The method of claim 7, further including:
determining that graphics processor activity has occurred while the display panel is in a self refresh mode; and
conducting a self refresh update of the display panel in response to the graphics processor activity.

11. The method of claim 10, wherein determining that the graphics processor activity has occurred includes checking an activity bit.

12. The method of claim 10, wherein the occurrence of the graphics processor activity is determined without notification of a frame buffer switch.

13. At least one computer readable storage medium comprising a set of instructions which, if executed by a computing device, cause the computing device to:
detect a content change with respect to one or more frame buffers associated with a display panel;
identify a command set associated with a previous update of the display panel; and
re-use the command set to conduct a subsequent update of the display panel.

14. The at least one computer readable storage medium of claim 13, wherein the subsequent update of the display panel is to bypass one or more drivers associated with the display panel.

15. The at least one computer readable storage medium of claim 13, wherein the instructions, if executed, cause the computing device to check the one or more frame buffers for the content change on a periodic basis.

16. The at least one computer readable storage medium of claim 13, wherein the instructions, if executed, cause the computing device to:
determine that graphics processor activity has occurred while the display panel is in a self refresh mode; and
conduct a self refresh update of the display panel in response to the graphics processor activity.

17. The at least one computer readable storage medium of claim 16, wherein the instructions, if executed, cause the computing device to check an activity bit to determine that the graphics processor activity has occurred.

18. The at least one computer readable storage medium of claim 16, wherein the occurrence of the graphics processor activity is to be determined without notification of a frame buffer switch.

19. An apparatus comprising:
content logic, implemented at least partly in fixed-functionality hardware, to,
detect a content change with respect to one or more frame buffers associated with a display panel,
identify a command set associated with a previous update of the display panel, and
re-use the command set to conduct a subsequent update of the display panel.

20. The apparatus of claim 19, wherein the subsequent update of the display panel is to bypass one or more drivers associated with the display panel.

21. The apparatus of claim 19, wherein the content logic is to check the one or more frame buffers for the content change on a periodic basis.

22. The apparatus of claim 19, further including:
self refresh logic, implemented at least partly in fixed-functionality hardware, to,
determine that graphics processor activity has occurred while the display panel is in a self refresh mode, and
conduct a self refresh update of the display panel in response to the graphics processor activity.

23. The apparatus of claim 22, wherein the self refresh logic is to check an activity bit to determine that the graphics processor activity has occurred.

24. The apparatus of claim 22, wherein the occurrence of the graphics processor activity is to be determined without notification of a frame buffer switch.
